(19) United States
(12) Patent Application Publication
(10) Pub. No.: US 2003/0159882 A1
(43) Pub. Date: Aug. 28, 2003

(54) Safety line clamp for high rise buildings

(76) Inventor: Edward E. Franckewich JR., Miami, FL (US)

Correspondence Address: Robert M. Downey, ROBERT M. DOWNEY, P.A., Suite 350, 150 E. Palmetto Park Road, Boca Raton, FL, 33432, US

(21) Appl. No.: 10/083,438

(22) Filed: Feb. 25, 2002

(51) Int. Cl. A62B 1/16

(52) U.S. Cl. 182/82; 182/3

(57) ABSTRACT

A clamp anchors to the edge of a floor slab of a high-rise building for securing a safety line in a fall arrest system. The clamp has a one-piece, generally C-shaped body including upper and lower plates which extend perpendicularly from an end plate to define a mouth for receiving the peripheral edge of the floor slab between the upper and lower plates. Bolts fitted through the upper plate are tightened against the top of the floor slab, thereby grasping the floor slab between the distal ends of the bolts and the lower plate. The upper plate, lower plate and end plate are provided with reinforcing members to resist bending and deforming of the clamp body when under load. A U-shaped eyelet extends down from the end plate for attaching the safety line to the clamp. Handle members on the upper plate facilitate placement, removal and transport of the clamp.

### BACKGROUND OF THE INVENTION

1. Field of the Invention

This invention relates generally to safety equipment in the field of construction and, more particularly, to a device for securing a safety line or lifeline of a fall arrest system used during the construction of a high-rise building.

2. Discussion of the Related Art

In construction work, and particularly in the construction of high-rise buildings, it is necessary to provide workers with safety equipment to protect them in the event of an accidental fall. Today, most equipment serving the purpose of protecting workers from falling off a building is said to constitute a fall restraint and/or a fall arrest system. In high-rise building construction, the fall restraint system uses one or more safety lines (also referred to as lifelines) which are secured at one end to equipment on the roof of the building or near the top of the building. Once properly anchored, the safety lines are dropped down so that they extend vertically on the exterior sides of the building. When it is necessary to perform work on an unfinished balcony or other open ledge which does not have a safety railing, a construction worker is required to hook up to the safety line. Normally, construction workers wear a safety harness and use a lanyard which connects between the harness and the safety line. The lanyard is fitted with special hardware which enables quick attachment to the safety line when necessary. The hardware fitting is designed to grasp and lock onto the safety line when pulled in a downward motion. In the event a worker accidentally falls from the building, a lanyard connecting between the lifeline and safety harness will limit the distance of the fall (normally less than 10 feet). The lanyard is structured to absorb the soft of a fallen worker, thereby preventing a sudden and harmful jerk when the lanyard is pulled taut between the safety line and the harness.

The modern-day fall arrest systems, as described above, are highly effective and useful in high-rise building construction. Nonetheless, various problems are commonly encountered, particularly in the manner in which the upper end of the safety line is secured to the building. In some instances, an elaborate anchoring platform apparatus is used on the roof of a building for securing multiple safety lines. A rooftop safety line anchoring apparatus of this nature is expensive, cumbersome and difficult to install and remove. Moreover, anchoring the end of the safety line on the rooftop requires the safety line to extend over parapet walls and decorative facia on the upper perimeter of the building. This is particularly problematic due to the extent of use of Styrofoam deco on the exterior of many modern-day buildings. More specifically, safety lines and other ropes will easily cut through Styrofoam deco used in the construction of parapet walls and decorative facia on buildings. Therefore, safety lines cannot be secured to the rooftop and draped over parapet walls and decorative facia on buildings which use Styrofoam deco.

In some instances, safety lines are secured to interior structures, such as columns within the building. This method of anchoring the safety line is not generally accepted as being safe. In addition to causing an obstruction within the interior work space of the building, extending the safety line from an interior column and outwardly down the side of the building can cause the safety line to become chafed from rubbing on the edge of balcony decks or ledges. For this reason, it is preferred that the safety line extend in one direction only, namely vertically, so that the safety line does not drape over and rub against edges of parapet walls, eaves drips, facia, balconies, ledges and other structures of the building.

Accordingly, there remains an urgent need in the construction industry for a device which allows for easy, effective and safe anchoring of safety lines to a high-rise building structure without damaging the building structure or safety line.

### OBJECTS AND ADVANTAGES OF THE INVENTION

With the foregoing in mind, it is a primary object of the present invention to provide a device used in a fall arrest system for securing a safety line to a high-rise building without damaging the building structure or the safety line.

It is a further object of the present invention to provide a device for securing a safety line of a fall arrest system to a building without damaging decorative Styrofoam and other decorative structure of the building.

It is still a further object of the present invention to provide a device for securing a safety line of a fall arrest system to a high-rise building so that the safety line extends vertically along the exterior side of the building without rubbing against edges of parapet walls, eaves drips, decorative facia, balconies, ledges or other structure on the high-rise building.

It is yet a further object of the present invention to provide a device for conveniently securing the safety line of a fall arrest system to a high-rise building, and wherein the device can be easily installed, removed and/or relocated by a single person.

It is still a further object of the present invention to provide a clamp device for securing a safety line of a fall arrest system to a high-rise building, and wherein the clamp device is structured and disposed to anchor to the edge of a balcony deck or other floor slab structure of the building, so that the safety line extends vertically down on the exterior of the building, without rubbing against decorative Styrofoam or other delicate structure on the exterior of the building.

It is still a further object of the present invention to provide a clamp device for securing a safety line of a fall arrest system to a high-rise building, and wherein the clamp device is structured and disposed to removably anchor to parapet walls where no decorative Styrofoam is used.

It is still a further object of the present invention to provide a device for securing a safety line of a fall arrest system to a high-rise building, and wherein the device is relatively inexpensive and easy to transport, install, remove and relocate, thereby enabling multiple safety lines to be installed on a single building without great expense.

It is yet a further object of the present invention to provide a device for securing a safety line of a fall arrest system used in the construction of a high-rise building, and wherein the device is adapted to easily anchor to the edge of a balcony, floor slab or parapet wall, and further wherein the device meets or exceeds the requirements of the Occupational Safety and Health Administration (OSHA).

These and other objects and advantages of the present invention are more readily apparent with reference to the following description and accompanying drawings.

### SUMMARY OF THE INVENTION

The present invention is directed to a clamp device which anchors to the edge of a floor slab, such as the edge of a balcony or ledge, on a high-rise building for securing a safety line in a fall arrest system. The clamp device has a one-piece, generally C-shaped body including upper and lower plates which extend perpendicularly from an end plate to define a mouth for receiving the peripheral edge of the floor slab between the upper and lower plates. Bolts fitted through the upper plate are tightened against the top of the floor slab, thereby grasping the floor slab between the distal ends of the bolts and the lower plate of the clamp. The upper plate, lower plate and end plate are provided with reinforcing members to resist bending and deforming of the clamp body when under load. A U-shaped islet extends downwardly from the end plate for attaching the safety line to the clamp. Handle members on the upper plate facilitate placement removal, transport and relocation of the clamp.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view showing the safety line clamp of the present invention installed as part of a fall arrest system in a high-rise building, and wherein the safety line clamp is anchored to the edge of a balcony floor slab with a safety line secured thereto and extending downwardly along the side of the building;

FIG. 2 is an isolated perspective view, in partial cutaway, taken from the area indicated as FIG. 2 in FIG. 1;

FIG. 3 is a side elevational view, in partial section, showing the safety line clamp anchored to the edge of the floor slab of a balcony with an upper end of a safety line secured thereto;

FIG. 4 is an isolated top plan view showing the safety line clamp anchored to the floor slab of a balcony;

FIG. 5 is a left end elevational view of the safety line clamp shown in FIG. 3; and

FIG. 6 is a right end elevational view, in partial section, of the safety line clamp of FIG. 3, shown anchored to the floor slab of a balcony in a high-rise building under construction.

Like reference numerals refer to like parts throughout the several views of the drawings.

### DETAILED DESCRIPTION OF THE PREFERRED EMBODIMENT

Referring to the several views of the drawings, the safety line clamp of the present invention is shown and is generally indicated as 10.

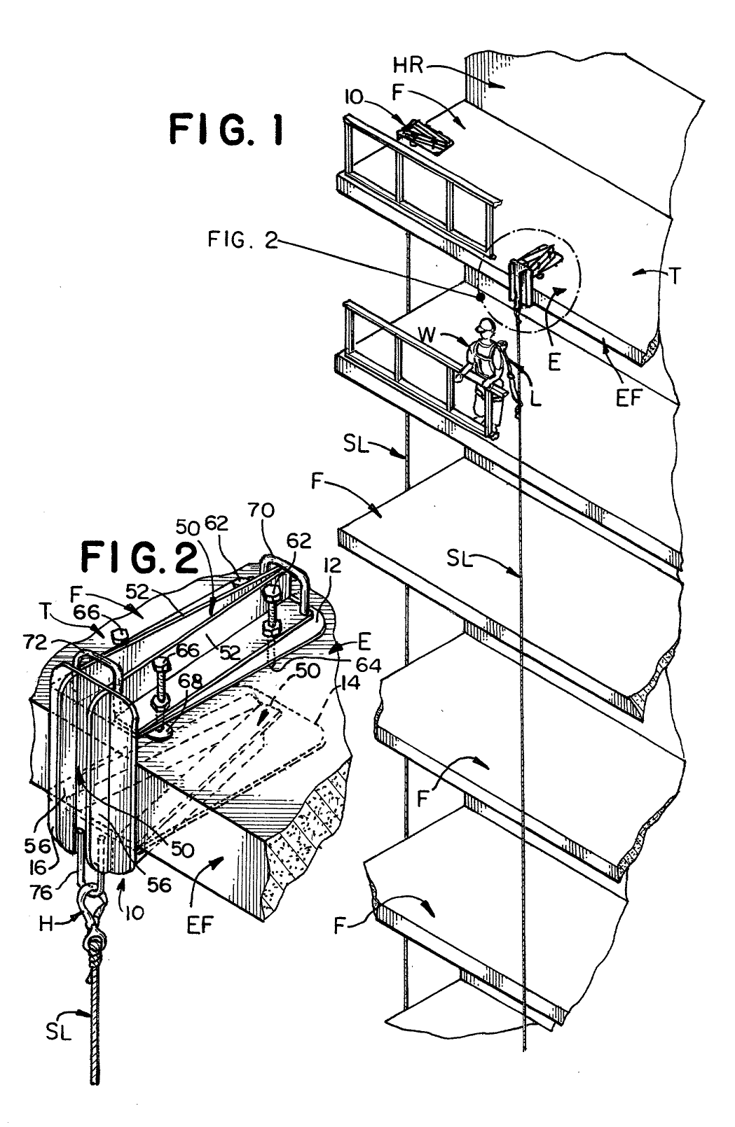

As seen in FIG. 1, the safety line clamp 10 is intended for use as part of a fall arrest system to protect workers W during the construction of a high-rise building HR. More particularly, the safety line clamp 10 is used to secure a safety line SL of the fall arrest system, allowing the safety line SL to hang freely down along the sides of the high-rise building HR without damaging the safety line SL or the building structure. The clamp 10 is specifically adapted to removably anchor to the edge of a floor slab, such as on a balcony or an open side of the high-rise building during construction. As seen in FIG. 1, when a worker W is working near a ledge or balcony which is not enclosed by protective railing, the worker is required to connect to the safety line SL. Approved fall arrest systems include the use of a harness which is worn by workers at all times, particularly when working on or near open ledges or balconies. A lanyard L connects between the harness on the worker W and the safety line SL. In the event the worker W accidentally falls from the floor slab F of the balcony, or other unprotected open sides of the building, the lanyard L connecting between the harness and safety line SL will limit the worker's fall to a distance which is less than the distance to the next lower floor level. The lanyard L is fitted with a shock absorbing feature which will cushion the worker's fall, thereby preventing a sudden jerk and injury to the worker W. When the worker W moves to another location on the balcony, he can disconnect from one safety line SL and reconnect his lanyard L to another safety line, such as along the side edge of the floor slab F of the balcony, as seen in FIG. 1.

The clamp 10 of the present invention is specifically structured to allow for convenient attachment to the peripheral edge E of the floor slab F of a balcony or other ledge, and can be easily removed and relocated, when necessary.

As best seen in FIGS. 2-6, the clamp 10 of the present invention anchors to the peripheral edge E of the floor slab F. When properly anchored, the one-piece body 11 of the clamp 10 butts up against the outer edge face EF of the floor slab F and clamps to the top surface T and bottom surface B of the floor slab F.

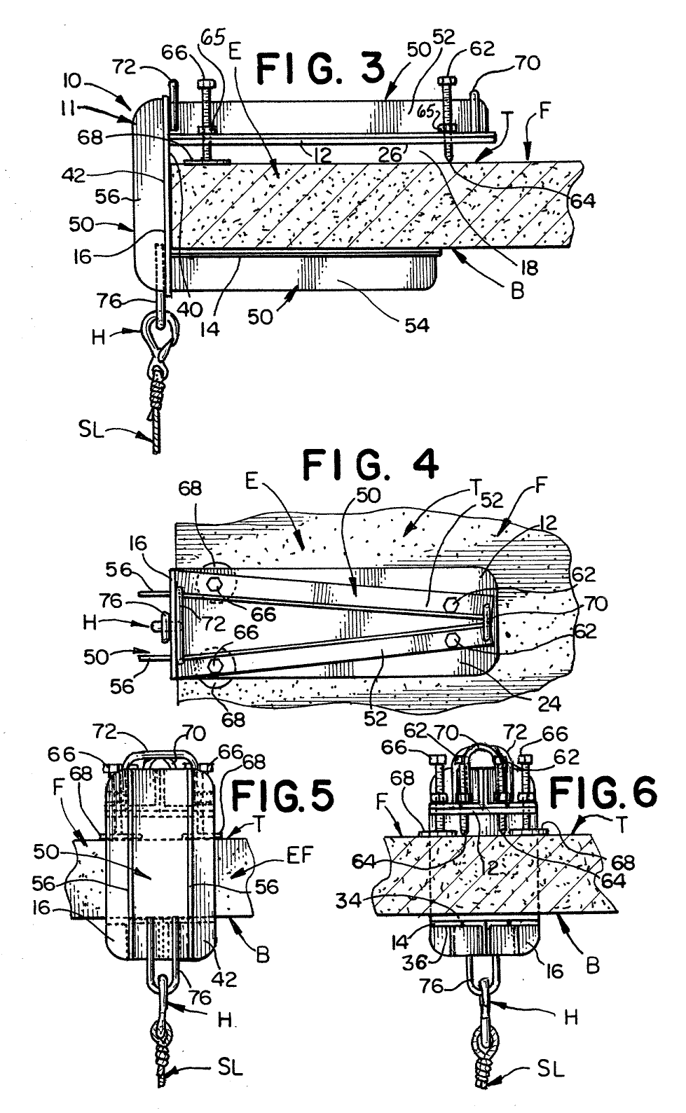

The one-piece body 11 of the clamp 10 includes an upper plate 12, a lower plate 14 and an end plate 16. In a preferred embodiment, the upper plate 12 and lower plate 14 are welded to an inner face 40 of the end plate 16 and extends generally perpendicularly therefrom, in spaced parallel relation to define a mouth 18 between the upper and lower plates. The upper and lower plates are spaced sufficiently from one another to permit receipt of the peripheral edge E of the floor slab F within the mouth 18 of the clamp 10 and between the upper and lower plates, as seen in FIGS. 3 and 6. In a preferred embodiment, all of the components of the clamp, as described hereinafter, are made of steel. The upper plate 12, lower plate 14 and end plate 16 are preferably formed of one-eighth inch steel.

The clamp body 11 is provided with reinforcing means 50 to provide stiffening and to resist bending and deforming of the clamp body when subjected to load stresses. In a preferred embodiment, the reinforcing means 50 includes a pair of L-shaped steel angle braces 52 welded to a top side 24 of the upper plate 12 and a pair of L-shaped steel angle braces 54 welded to a bottom side 36 of the lower plate 14. The reinforcing means further includes steel stiffeners 56 welded to the outer face 42 of the end plate 16, as seen in FIGS. 2-5.

To secure the clamp to the peripheral edge E of the floor slab F, the clamp body 11 is slid over the peripheral edge E of the floor slab F so that the upper plate 12 is above the top surface T of the floor slab F and the lower plate 14 is below the bottom surface B of the floor slab F. The clamp body 11 is positioned so that the inner face 40 of the end plate 16 butts against the edge face EF of the floor slab F, as best seen in FIGS. 2 and 3.

Tightening means 60 are provided for clamping the clamp body 11 onto the peripheral edge E of the floor slab F so that the clamp 10 is properly anchored in secured, fixed position. The tightening means 60 includes the use of a first pair of bolts 62 and a second pair of bolts 66. The first pair of bolts 62 extend down through the angle braces 52 and upper plate 12 near an inboard end and terminate at pointed tips 64. When the clamp body 11 is properly positioned for anchoring to the floor slab F, the bolts 62 are tightened so that the pointed tips 64 engage the top surface T of the floor slab F, raising the clamp body 11 until the top side 34 of the lower plate 14 mates against the bottom surface B of the floor slab F, as best seen in FIG. 3. The second pair of bolts 66 are also tightened to cause circular plates 68 on the ends of the bolts 62 to mate against the top surface T of the floor slab F which serves to also raise the clamp body 11 relative to the floor slab F and position the top side 34 of the lower plate 14 against the bottom surface B of the floor slab F (see FIG. 3). When in this position, continued tightening of the bolts 62 causes the pointed tips 64 to bite into the top surface T as the floor slab F is squeezed between the bolt tips 64 and top side 34 of the lower plate 14. Likewise, the bolts 66 are tightened further to press the circular plates 68 against the top surface T, thereby squeezing the floor slab F between the circular plates 68 and the top side 34 of the lower plate 14. The combined biting force of the pointed distal tips 64 and the pressing force of the circular plate 68, as described above, serves to anchor the clamp body 11 to the peripheral edge E of the floor slab. Once the clamp 10 is properly anchored, as seen throughout the drawing figures, the safety line SL can be attached to the clamp 10. Specifically, a U-shaped steel bar 76, forming an eyelet, is welded to the outer face 42 of the end plate 16. The eyelet formed by the U-shaped steel bar 76 extends down below the bottom edge of the end plate 16 and is specifically structured and disposed for attachment of a hook H on the upper end of the safety line SL. Typically, the hook H is of a normally closed type, as seen in FIG. 3, to prevent accidental detachment of the safety line SL from the clamp 10.

To facilitate transport, installation, removal and repositioning of the clamp 10, the clamp body 11 is fitted with handle means. Specifically, a U-shaped handle 70, formed of a steel bar, is welded to the top side 24 of the upper plate 12, towards the inboard end. Further, a U-shaped handle 72 formed of a steel bar is welded to the top side 24 of the upper plate 12 near the outboard side, and preferably welded against the inner face 40 of the end plate 16.

While the instant invention has been shown and described in accordance with preferred and practical embodiments thereof, it is recognized that departures from the instant disclosure are contemplated within the spirit and scope of the present invention which should not be limited except as defined in the following claims under the doctrine of equivalents.

What is claimed is:

1. A device for securing a safety line of a fall arrest system on a building having at least one floor slab with an outer peripheral edge including an edge face, a top surface and a bottom surface, said device comprising:
a clamp body having upper and lower members spaced apart for receiving the peripheral edge of the floor slab therebetween;
anchoring means for grasping the peripheral edge of the floor slab between said upper and lower members of said clamp body in order to hold said clamp body on the floor slab; and
attachment means for releasably securing the safety line to said clamp body.

2. The device as recited in claim 1 wherein said clamp body further comprises an end plate extending between said upper and lower members.

3. The device as recited in claim 2 wherein:
said upper member of said clamp body is defined by an upper plate extending perpendicularly from said end plate;
said lower member of said clamp body is defined by a lower plate extending perpendicularly from said end plate in spaced relation to said upper plate; and
said spaced parallel upper and lower and plates defining a clamp mouth therebetween for receiving the outer peripheral edge of the floor slab between said upper and lower plates.

4. The device as recited in claim 3 wherein said anchoring means includes a first anchoring means for applying a biting force on the floor slab in order to hold said clamp body on the floor slab.

5. The device as recited in claim 4 wherein said anchoring means further comprises second anchoring means for applying a squeezing force on the top and bottom surfaces of the peripheral edge of the floor slab in order to hold said clamp body on the floor slab.

6. The device as recited in claim 3 further comprising reinforcing means on said clamp body for resisting bending and deforming of said clamp body when load forces are applied thereto.

7. The device as recited in claim 6 wherein said reinforcing means comprises brace members attached to at least one exterior surface of said clamp body.

8. The device as recited in claim 7 wherein said brace members are attached to the exterior side faces of said upper plate, said lower plate, and said end plate.

9. The device as recited in claim 3 wherein said clamp body includes handle means to facilitate installation, removal and carrying of the device.

10. A device for securing a safety line of a fall arrest system on a building having at least one floor slab with an outer peripheral edge including an edge face, a top surface, and a bottom surface; said device comprising:
a clamp body including:
an end plate with an inner face;
an upper plate extending perpendicularly from said inner face of said end plate;
a lower plate extending perpendicularly from said inner face of said end plate in spaced, parallel relation to said upper plate; and
said spaced, parallel upper and lower plates defining a clamp mouth for receiving the outer peripheral edge of the floor slab between said upper and lower plates;
anchoring means for grasping the peripheral edge of the floor slab within said clamp mouth in order to hold said clamp body on the floor slab; and
attachment means for releasably securing the safety line to said clamp body.

11. The device as recited in claim 10 wherein said anchoring means comprises first anchoring means for applying a biting force on the peripheral edge of the floor slab.

12. The device as recited in claim 11 wherein said anchoring means further comprises second anchoring means for applying a squeezing force on the top surface and bottom surface of the peripheral edge of the floor slab.

13. The device as recited in claim 10 further comprising reinforcing means on said clamp body for resisting bending and deforming of said clamp body when load forces are applied thereto.

14. The device as recited in claim 13 wherein said reinforcing means comprises brace members attached to at least one exterior surface of said clamp body.

15. The device as recited in claim 10 wherein said clamp body includes handle means to facilitate installation, removal, and carrying of the device.
